(19) United States
(12) Patent Application Publication
(10) Pub. No.: US 2013/0339641 A1
(43) Pub. Date: Dec. 19, 2013

(54) INTEGRATED CIRCUIT CHIP AND MEMORY DEVICE

(71) Applicant: SK HYNIX INC., Gyeonggi-do (KR)

(72) Inventors: Sung-Hwa OK, Gyeonggi-do (KR); Kie-Bong KU, Gyeonggi-do (KR); Hye-Young LEE, Gyeonggi-do (KR); Sejin YOO, Gyeonggi-do (KR)

(73) Assignee: SK HYNIX INC., Gyeonggi-do (KR)

(21) Appl. No.: 13/717,552

(22) Filed: Dec. 17, 2012

(30) Foreign Application Priority Data
Jun. 13, 2012 (KR) 10-2012-0063265

(51) Int. Cl. G06F 12/06

(52) U.S. Cl. CPC G06F 12/0646
USPC 711/158

(57) ABSTRACT

A memory device includes a pad that provides an interface with an exterior, a first setting unit that generates a termination setting signal for setting the pad for a purpose of termination data strobe using a first specific code of a mode register set operation, a second setting unit that generates a mask setting signal for setting the pad for a purpose of data mask using a second specific code of the mode register set operation, and a third setting unit that generates a write inversion setting signal for setting the pad for a purpose of write data bus inversion using third specific code of the mode register set operation. When a setting signal with a higher priority is activated, a setting signal with a lower priority is deactivated regardless of a value of the corresponding code.

### CROSS-REFERENCE TO RELATED APPLICATIONS

The present application claims priority of Korean Patent Application No. 10-2012-0063265, filed on Jun. 13, 2012, which is incorporated herein by reference in its entirety.

### BACKGROUND

1. Field

Exemplary embodiments of the present invention relate to a memory device, and more particularly, to a technology for setting a pad of a memory device to perform various functions.

2. Description of the Related Art

In a memory field, there have been increasing demands for low power consumption and a high speed operation, and memory devices of new standards are continuously provided according to such demands. Meanwhile, new functions are gradually added to the memory devices, resulting in an increase in the number of pins (or balls) in the memory devices.

FIG. 1 is a diagram illustrating a part of a package ball arrangement in a memory device.

Referring to FIG. 1, in the case of balls VSSQ, VSS, VDD, and VDDQ for power supplying, a ball ZQ for ZQ calibration, and balls DQ1, DQ3, and DQ5 for data input/output, one function is assigned to a physical one ball. However, three functions of a data mask, a data bus inversion, and a termination data strobe are assigned to a ball (or pin) 101. One ball 101 physically exists, but may be used for one function of the data mask, the data bus inversion, and the termination data strobe according to mode setting. In other words, the ball 101 is selectively used for data mask pin (DM), a data bus inversion pin (DBI), or a termination data strobe pin (TDQS).

For example, in a mode register set 1 (MR1) of a mode register set (MRS) operation, when a address A<11> is ‘1’, the ball 101 is set to be used for the TDQS function, and when the address A<11> in the mode register 1 is ‘0’, the ball 101 is not used for the TDQS function. Furthermore, in a mode register set 5 (MR5) of the mode register set operation, when a address A<10> is ‘1’, the ball 101 is set to be used for the DM function, and when the address A<10> of the mode register set 5 (MR5) is ‘0’ the ball 101 is not used for the DM function. Furthermore, in the mode register set 5 (MR5) of the mode register set operation, when a address A<11> is ‘1’, the ball 101 is set to be used for the DBI (WDBI: Write DBI) function in a write operation, and when the address A<11> of the mode register set 5 (MR5) is ‘0’, the ball 101 is not used for the WDBI function. Furthermore, in the mode register set 5 (MR5) of the mode register set operation, when a address A<12> is ‘1’, the ball 101 is set to be used for the DBI (RDBI: Read DBI) function in a read operation, and when the address A<12> of the mode register set 5 (MR5) is ‘0’, the ball 101 is not used for the RDBI function.

As described above, an example, which one ball (or pin) is used in order to support one of various functions according to mode setting, is frequently used in various integrated circuit chips as well as the memory device.

### SUMMARY

Exemplary embodiments of the present invention are directed to alleviate a concern that a normal operation may not be possible when settings are duplicated, in an integrated circuit chip in which one ball may be used for one of various functions.

In accordance with an embodiment of the present invention, a memory device includes a pad configured to provide an interface with an exterior, a first setting unit configured to generate a termination setting signal for setting the pad for a purpose of termination data strobe using a first specific code of a mode register set operation, a second setting unit configured to generate a mask setting signal for setting the pad for a purpose of data mask using a second specific code of the mode register set operation, and a third setting unit configured to generate a write inversion setting signal for setting the pad for a purpose of write data bus inversion using third specific code of the mode register set operation, wherein a priority is assigned to the termination setting signal, the mask setting signal, and the write inversion setting signal, and when a setting signal with a higher priority is activated, a setting signal with a lower priority is deactivated regardless of a value of the corresponding code.

In accordance with another embodiment of the present invention, an integrated circuit chip includes a pad configured to provide an interface with an exterior, a first setting unit configured to generate a first setting signal for setting the pad as a pad for a first function using first setting information, and a second setting unit configured to generate a second setting signal for setting the pad as a pad for a second function using second setting information, wherein a priority is assigned to the first setting signal and the second setting signal, and when a setting signal with a higher priority is activated, a setting signal with a lower priority is deactivated regardless of a value of the setting information.

According to the embodiments of present invention, even when a function of a pad is erroneously set due to duplication, only a setting with the highest priority is activated based on priorities set in advance, so that an abnormal operation due to erroneous settings may be prevented.

### BRIEF DESCRIPTION OF THE DRAWINGS

FIG. 1 is a diagram illustrating a part of a package ball arrangement in a memory device.

FIG. 2 is a block diagram of a memory device in accordance with an embodiment of the present invention.

FIG. 3 is a detailed diagram of a setting circuit shown in FIG. 2 in accordance with an embodiment.

FIG. 4 is a detailed diagram of a mask performing unit and a data inversion unit shown in FIG. 2 in accordance with an embodiment.

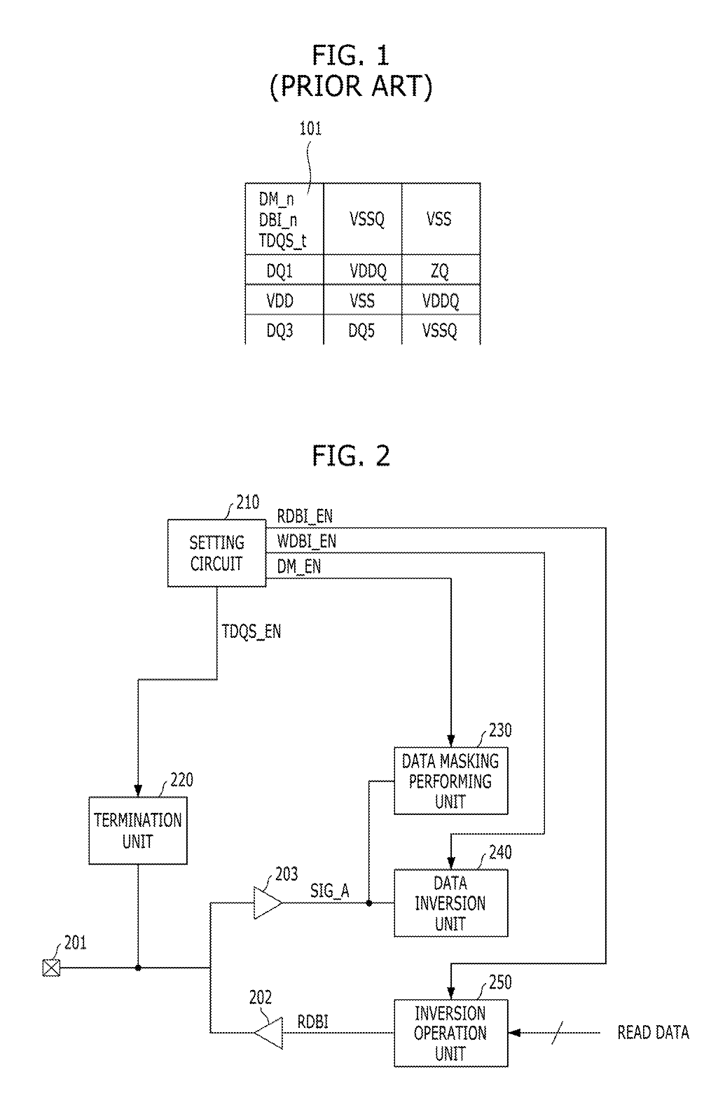

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. In this specification, a singular form may include a plural form as long as it is not specifically mentioned in a sentence.

FIG. 2 is a block diagram of a memory device in accordance with an embodiment of the present invention.

Referring to FIG. 2, the memory device includes a pad 201, to which a package ball (or pin) is connected, a setting circuit 210, a termination unit 220, a input buffer 203, a output driver 202, a data masking unit 230, a data inversion unit 240, and an inversion operation unit 250.

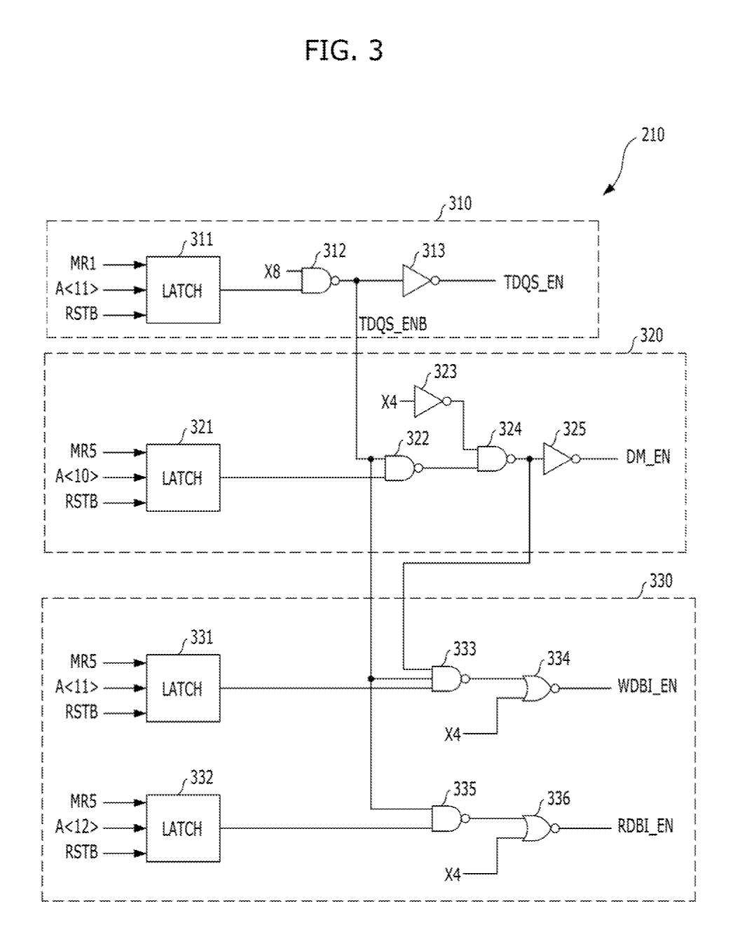

The setting circuit 210 is configured to set the pad 201 in order to support a predetermined function. For example, a termination setting signal TDQS_EN generated in the setting circuit 210 is set such that the pad 201 is used for a termination function. A mask setting signal DM_EN generated in the setting circuit 210 is set so that the pad 201 is used for a data mask function. Inversion setting signals RDBI_EN and WDBI_EN generated in the setting circuit 210 are set so that the pad 201 is used for a data bus inversion function. As described in the conventional art, the settings of the pad 201 may be duplicated, and when the settings of the pad 201 are duplicated, a normal operation of the memory device may not be ensured. The setting circuit 210 of the embodiment of the present invention substantially prevents such duplicate setting. The configuration and operation of the setting circuit 210 will be described in detail later with reference to FIG. 3.

The termination unit 220 is configured to have a function that is activated by the termination setting signal TDQS_EN. When the termination setting signal TDQS_EN is activated, the termination unit 220 terminates the pad 201 in the same manner as that of a data strobe pad DQS_t/DQS_c PAD (not illustrated). That is, the termination unit 220 terminates the pad 201 with a resistance value substantially equal to a termination resistance value of the data strobe pad DQS_t/DQS_c PAD in a period in which the data strobe pad DQS_t/DQS_c PAD is terminated.

The input buffer 203 is configured to receive a signal input from the pad 201, and transfer the signal to the data masking unit 230 and the data inversion unit 240. The input buffer 203 may be designed to be activated only in a period in which one or more of the write inversion setting signal WDBI_EN and the mask setting signal DM_EN is activated and the signal is input through the pad 201.

The output driver 202 is configured to output read inversion information RBI generated by the inversion operation unit 250 to the pad 201. The output driver 202 may be designed to be activated only in a period (this period is substantially equal to a period in which the read inversion setting signal RDBI_EN is output from the memory device) in which the read inversion setting signal RDBI_EN is activated and read data is output from the memory device.

The data masking performing unit 230 is configured to have a function which is activated by the mask setting signal DM_EN. In the case in which the mask setting signal DM_EN is activated, the data masking unit 230 masks write data input from an exterior of the memory device (substantially prevents the write data from being written in a cell array) when the level of a signal SIG_A input to the pad 201 is ‘0’, and does not mask the write data when the level of the signal SIG_A input to the pad 201 is ‘1’.

The data inversion unit 240 is configured to have a function that is activated by the write inversion setting signal WDBI_EN. In the case in which the write inversion setting signal WDBI_EN is activated, the data inversion unit 240 inverts the write data when the level of the signal SIG_A input to the pad 201 is ‘0’ and does not invert the write data when the level of the signal SIG_A input to the pad 201 is ‘1’.

The inversion operation unit 250 is configured to have a function that is activated by the read inversion setting signal RDBI_EN. When the read inversion setting signal RDBI_EN is activated, the inversion operation unit 250 generates the read inversion information RDBI using read data READ DATA and outputs the generated read inversion information RDBI to the pad 201 through the output driver 202. The read inversion information RDBI output from the inversion operation unit 250 indicates whether data output to a data pad DQ PADs (not illustrated) of the memory device has been inverted. The data output to the data pad of the memory device is inverted or not inverted based on the read inversion information RDBI generated by the inversion operation unit 250. Since the inversion operation unit 250 is well-known to those skilled in the art, a more detailed description thereof will be omitted.

FIG. 3 is a detailed diagram of the setting circuit 210 shown in FIG. 2 in accordance with an embodiment.

Referring to FIG. 3, the setting circuit includes a first setting unit 310, a second setting unit 320, and a third setting unit 330. The first setting unit 310 is configured to generate the termination setting signal TDQS_EN for setting the pad 201 for the purpose of termination data strobe using a first specific bit (MRS code) A<11> of MR1 of the mode register set operation. The second setting unit 320 is configured to generate the mask setting signal DM_EN for setting the pad 201 for the purpose of data mask using a second specific bit A<10> of MRS of the mode register set operation. The third setting unit 330 is configured to generate one or more inversion setting signals RDBI_EN and WDBI_EN for setting the pad 201 for the purpose of data bus inversion using third specific bits A<11> and A<12> of MR5 of the mode register set operation. Furthermore, a priority is assigned to the termination setting signal TDQS_EN, the mask setting signal DM_EN, and the write inversion setting signal WDBI_EN, and when a setting signal with a higher priority is activated, setting signals with a lower priority are deactivated regardless of the value of the mode register set. Hereinafter, for the purpose of convenience, it is assumed that a priority is assigned in the sequence of the termination setting signal TDQS_EN, the mask setting signal DM_EN and the write inversion setting signal WDBI_EN. Furthermore, it is assumed that the read inversion setting signal RDBI_EN has a priority lower than that of the termination setting signal TDQS_EN, but has no priority in relation to the other setting signals DM_EN and WDBI_EN.

The first setting unit 310 is configured to activate or deactivate the termination setting signal TDQS_EN based on a value stored in a latch 311. The latch 311 is configured to store a value of the address A<11> when the mode register 1 is selected by a mode register set command, that is, the MR1 signal is activated. In short, the latch 311 stores information on the address A<11> of the mode register 1. Basically, the first setting unit 310 activates the termination setting signal TDQS_EN when the value stored in the latch 311 is ‘1’, and deactivates the termination setting signal TDQS_EN when the value stored in the latch 311 is ‘0’. However, in a mode other than an X8 mode in which the memory device uses eight data pins for data input/output, that is, when an X8 signal is deactivated, the first setting unit 310 deactivates the termination setting signal TDQS_EN regardless of the value stored in the latch 311. This is because a data strobe termination function TDQS function is used only in the X8 mode. The first setting unit 310 may include the latch 311, a NAND gate 312, and an inverter 313 as illustrated in FIG. 3.

The second setting unit 320 is configured to activate or deactivate the mask setting signal DM_EN based on a value stored in a latch 321. The latch 321 is configured to store a value of the address A<10> when the mode register set 5 is selected by the mode register set command, that is, the MR5 signal is activated. In short, the latch 321 stores information on the address A<10> of the mode register set 5. Basically, the second setting unit 320 activates the mask setting signal DM_EN when the value stored in the latch 321 is ‘1’, and deactivates the mask setting signal DM_EN when the value stored in the latch 321 is ‘0’. However, in an X4 mode in which the memory device uses 4 data pins for data input/output, that is, when an X4 signal is activated, the second setting unit 320 deactivates the mask setting signal DM_EN regardless of the value stored in the latch 321. This is because a data mask function is not used in the X4 mode. Furthermore, when the termination setting signal TDQS_EN is activated, that is, when a signal TDQS_ENB is low, the second setting unit 320 deactivates the mask setting signal DM_EN regardless of the value stored in the latch 321. This is because the termination setting signal TDQS_EN having a priority higher than the mask setting signal DM_EN is activated. Through such operations, the second setting unit 320 may substantially prevent duplicate setting of the data strobe termination function TDQS function and the data mask function. The second setting unit 320 may include the latch 321, a NAND gate 322, an inverter 323, a NAND gate 324, and an inverter 325 as illustrated in FIG. 3.

The third setting unit 330 is configured to activate or deactivate the write inversion setting signal WDBI_EN based on a value stored in a latch 331, and to activate or deactivate the read inversion setting signal RDBI_EN based on a value stored in a latch 332. The latch 331 is configured to store a value of the address A<11> when the mode register set 5 is selected by the mode register set command, that is, the MR5 signal is activated. Furthermore, the latch 332 is configured to store a value of the address A<12> when the mode register set 5 is selected by the mode register set command, that is, the MR5 signal is activated. In short, the latch 331 stores information on the address A<11> of the mode register set 5 and the latch 332 stores information on the address A<12> of the mode register set 5. Basically, the third setting unit 330 activates the write inversion setting signal WDBI_EN when the value stored in the latch 331 is ‘1’ and deactivates the write inversion setting signal WDBI_EN when the value stored in the latch 331 is ‘0’. Furthermore, the third setting unit 330 activates the read inversion setting signal RDBI_EN when the value stored in the latch 332 is ‘1’, and deactivates the read inversion setting signal RDBI_EN when the value stored in the latch 332 is ‘0’. However, in the X4 mode in which the memory device uses 4 data pins, that is, when the X4 signal is activated, the third setting unit 330 deactivates the inversion setting signals WDBI_EN and RDBI_EN regardless of the values stored in the latches 331 and 332. This is because a data bus inversion function DBI function is not used in the X4 mode. Furthermore, when one of the termination setting signal TDQS_EN and the mask setting signal DM_EN is activated, the third setting unit 330 deactivates the write inversion setting signal WDBI_EN regardless of the value stored in the latch 331. This may substantially prevent duplicate setting when a signal having a priority higher than the write inversion setting signal WDBI_EN is activated. Furthermore, when the termination setting signal TDQS_EN is activated, the third setting unit 330 deactivates the read inversion setting signal RDBI_EN regardless of the value stored in the latch 332. The third setting unit 330 may include the latch 331, the latch 332, a NAND gate 333, a NOR gate 334, a NAND gate 335, and a NOR gate 336 as illustrated in FIG. 3.

Furthermore, there is no priority relationship between the inversion setting signals WDBI_EN and RDBI_EN. When the write inversion setting signal WDBI_EN is activated, the pad 201 is used in order to support the data bus inversion function in the write operation. When the read inversion setting signal RDBI_EN is activated, the pad in 201 is used in order to support the data bus inversion function in the read operation. However, since the write operation and the read operation are not simultaneously performed, even though the two signals WDBI_EN and RDBI_EN are activated, the pad 201 is not erroneously used due to duplication. Furthermore, there is no priority relationship between the read inversion setting signal RDBI_EN and the mask setting signal DM_EN. This is because the read data bus inversion function RDBI function is used in the read operation and the data mask function is used in the write operation. As a result, a problem of duplication may be prevented.

The setting circuit of FIG. 3 may substantially prevent duplicate setting for the function of the pad 201, thereby substantially preventing an abnormal operation of the memory device. The memory device is used in various applications, and there are many examples in which settings are duplicated according to applications. In addition, the setting circuit 210 of the embodiment of the present invention may substantially prevent such duplicate setting, thereby enabling an operation with applications which do not exactly satisfy memory specifications.

In FIG. 3, a priority is assigned in the sequence of the termination setting signal TDQS_EN, the mask setting signal DM_EN, and the write inversion setting signal WDBI_EN, and a priority is assigned in the sequence of the termination setting signal TDQS_EN and the read inversion setting signal RDBI_EN, which represents that the priority is assigned in the sequence of functions frequently used. The priority among the setting signals TDQS_EN, DM_EN, WDBI_EN, and RDBI_EN may be changed according to the sequence of functions frequently used in applications using the memory device.

In FIG. 3, a reset signal RSTB input to the latches 311, 321, 331, and 332 is used in order to initialize data stored in the latches 311, 321, 331, and 332 in a reset operation of the memory device.

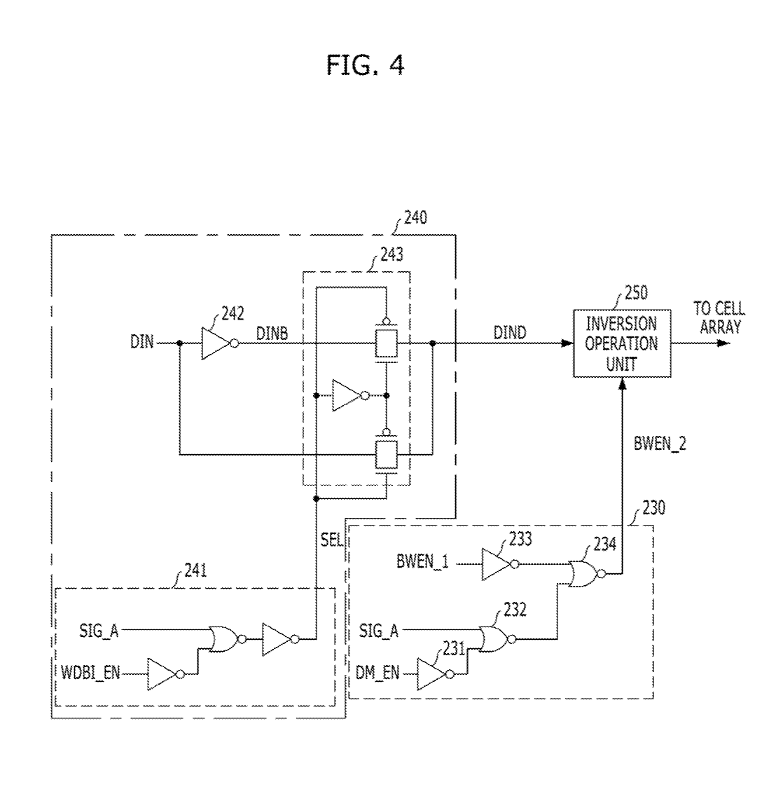

FIG. 4 is a detailed diagram of the data masking performing unit 230 and the data inversion unit 240 shown in FIG. 2 in accordance with an embodiment.

Referring to FIG. 4, the data inversion unit 240 includes a selection generation section 241, an inverter 242, and a selection section 243. The selection generation section 241 is configured to (1) generate a selection signal SEL to a level ‘1’ at the time of deactivation of the write inversion setting signal WDBI_EN, (2) generate the selection signal SEL to ‘1’ when the level of the signal SIG_A input to the pad 201 is ‘1’ at the time of activation of the write inversion setting signal WDBI_EN, and (3) generate the selection signal SEL to ‘0’ when the level of the signal SIG_A input to the pad 201 is ‘0’ at the time of activation of the write inversion setting signal WDBI_EN. As illustrated in FIG. 4, the selection generation section 241 may include two inverters and one NAND gate. The inverter 242 is configured to invert write data DIN input from an exterior of the memory device. The selection section 243 is configured to transfer the write data DIN to the inversion operation unit 250 when the selection signal SEL is ‘1’ (DIN=DIND), and to transfer write data DINB obtained by inverting the write data DIN through the inverter 242 to the inversion operation unit 250 when the selection signal SEL is ‘0’ (DINB=DIND). Accordingly, the data inversion unit 240 inverts or non-inverts the write data DIN based on the level of the signal SIG_A input to the pad 201 at the time of activation of the write inversion setting signal WDBI_EN.

In the state in which the mask setting signal DM_EN has been activated, when the level of the signal SIG_A input to the pad 201 is ‘0’, the data masking performing unit 230 substantially prevents an activation signal BWEN_{—}2 of the inversion operation unit 250 from being activated, and when the level of the signal SIG_A input to the pad 201 is ‘1’, the data masking performing unit 230 does not substantially prevent the activation signal BWEN_{—}2 of the inversion operation unit 250 from being activated. That is, (1) in the state in which the mask setting signal DM_EN has been deactivated, the data masking performing unit 230 controls the activation signal BWEN_{—}2 of the inversion operation unit 250 to be activated or deactivated based on the level of a control signal BWEN_{—}1. (2) In the state in which the mask setting signal DM_EN has been activated, when the level of the signal SIG_A input to the pad 201 is ‘1’, the data masking performing unit 230 controls the activation signal BWEN_{—}2 of the inversion operation unit 250 to be activated or deactivated based on the level of the control signal BWEN_{—}1. (3) In the state in which the mask setting signal DM_EN has been activated, when the level of the signal SIG_A input to the pad 201 is ‘0’, the data masking performing unit 230 controls the activation signal BWEN_{—}2 of the inversion operation unit 250 to substantially maintain a deactivated state regardless of the level of the control signal BWEN_{—}1. The data masking performing unit 230 may include an inverter 231, a NOR gate 232, an inverter 233, and a NOR gate 234 as illustrated in FIG. 4.

The control signal BWEN_{—}1 is activated in the write operation, and the inversion operation unit 250 transfers the write data DIND input from an exterior of the memory device to a cell array area CELL ARRAY when the activation signal BWEN_{—}2 is activated.

While the present invention has been described with respect to the specific embodiments, it will be apparent to those skilled in the art that various changes and modifications may be made without departing from the spirit and scope of the invention as defined in the following claims.

Furthermore, in the aforementioned embodiment, detailed setting values of the mode registers for setting the function of the pad are defined. However, these setting values may be changed or modified by specification regulations of the memory device.

Furthermore, in the aforementioned embodiment, the present invention is applied to the memory device. However, the present invention may be applied to all kinds of integrated circuit chips that perform a setting operation for using a pad for a function of at least two functions. In this case, a priority among the functions may be set such that a function frequently used has a priority higher than a function less frequently used. Furthermore, it may be possible to use a method for counting the number of times, at which a pad is set to a function A, and the number of times, at which the pad is set to a function B, using a counter circuit and the like, understanding a trend, and assigning a higher priority to a function in which the number of settings is large.

What is claimed is:

1. A memory device comprising:
a pad configured to provide an interface with an exterior;
a first setting unit configured to generate a termination setting signal for setting the pad for a purpose of termination data strobe using a first specific code of a mode register set operation;
a second setting unit configured to generate a mask setting signal for setting the pad for a purpose of data mask using a second specific code of the mode register set operation; and
a third setting unit configured to generate a write inversion setting signal for setting the pad for a purpose of write data bus inversion using third specific code of the mode register set operation,
wherein a priority is assigned to the termination setting signal, the mask setting signal, and the write inversion setting signal, and when a setting signal with a higher priority is activated, a setting signal with a lower priority is deactivated regardless of a value of the corresponding code.

2. The memory device of claim 1, wherein the second setting unit is configured to deactivate the mask setting signal when the termination setting signal is activated, and the third setting unit is configured to deactivate the write inversion setting signal when one or more of the termination setting signal and the mask setting signal are activated.

3. The memory device of claim 1, wherein the first setting unit is configured to deactivate the termination setting signal regardless of a logic value of the first specific code in a mode other than an X8 mode in which the memory device uses eight data pads for data input/output,
the second setting unit is configured to deactivate the mask setting signal regardless of a logic value of the second specific code in an X4 mode in which the memory device uses four data pads for data input/output, and
the third setting unit is configured to deactivate the write inversion setting signal regardless of a logic value of the third specific code in the X4 mode.

4. The memory device of claim 1, wherein the first specific code is a address A<11> of a first mode register set of the mode register set operation, the second specific code is a address A<10> of a second mode register set of the mode register set operation, and the third specific code are the address A<11> of the second mode register set of the mode register set operation.

5. The memory device of claim 1, further comprising:
a termination unit configured to terminate the pad when the termination setting signal is activated; and
a data masking unit configured to control write data to be written or not to be written in a cell array based on a logic level of a signal input to the pad when the mask setting signal is activated.

6. The memory device of claim 5, wherein the third setting unit is configured to generate a read inversion setting signal for setting the pad for a purpose of read data bus inversion, the read inversion setting signal having a priority lower than a priority of the termination setting signal, and the memory device further comprises:
a data inversion unit configured to invert or non-invert the write data based on the logic level of the signal input to the pad when the write inversion setting signal is activated; and
an inversion operation unit configured to generate read inversion information to be output to the pad using read data when the read inversion setting signal is activated.

7. An integrated circuit chip comprising:
a pad configured to provide an interface with an exterior;
a first setting unit configured to generate a first setting signal for setting the pad as a pad for a first function using first setting information; and
a second setting unit configured to generate a second setting signal for setting the pad as a pad for a second function using second setting information,
wherein a priority is assigned to the first setting signal and the second setting signal, and when a setting signal with a higher priority is activated, a setting signal with a lower priority is deactivated regardless of a value of the setting information.

8. The integrated circuit chip of claim 7, further comprising:
a third setting unit configured to generate a third setting signal for setting the pad as a pad for a third function using third setting information, and to deactivate the third setting signal regardless of the third setting information when the first setting signal or the second setting signal are activated.

9. The integrated circuit chip of claim 7, wherein, when the first function is frequently used compared to the second function, the first setting signal has a priority over the second setting signal, and when the second function is frequently used compared to the first function, the second setting signal has a priority over the first setting signal.
